(19) United States
(12) Patent Application Publication
(10) Pub. No.: US 2018/0001232 A1
(43) Pub. Date: Jan. 4, 2018

(54) DEVICE FOR PRODUCING WET GRANULATED SUBSTANCE FOR ELECTRODE AND METHOD OF PRODUCING THE SAME

(71) Applicant: TOYOTA JIDOSHA KABUSHIKI KAISHA, Toyota-shi (JP)

(72) Inventor: Naohisa AKIYAMA, Nagoya-shi (JP)

(73) Assignee: TOYOTA JIDOSHA KABUSHIKI KAISHA, Toyota-shi (JP)

(21) Appl. No.: 15/632,981

(22) Filed: Jun. 26, 2017

(30) Foreign Application Priority Data
Jun. 29, 2016 (JP) 2016-129070

(51) Int. Cl. B01D 21/26; H01M 4/04; B01F 7/00; C09D 127/12

(52) U.S. Cl. CPC B01D 21/26; H01M 4/0404; B01F 7/00008; C09D 127/12

(57) ABSTRACT

A device for producing a wet granulated substance for an electrode, the device including a storage tank in which a solid component is stored, liquid supply units configured to supply a liquid component, and a stirring member configured to stir the solid component and the liquid component together. The liquid supply unit includes a nozzle configured to allow the liquid component to drop, a pump configured to repeatedly switch between a first state in which a pressure is applied to the liquid component and a second state in which a lower pressure than in the first state is applied to the liquid component, and a rotating member that is provided between the nozzle and the storage tank, has a disk shape with irregularities formed on the edge, and rotates in a non-horizontal plane.

### INCORPORATION BY REFERENCE

The disclosure of Japanese Patent Application No. 2016-129070 filed on Jun. 29, 2016 including the specification, drawings and abstract is incorporated herein by reference in its entirety.

### BACKGROUND

### 1. Technical Field

The present disclosure relates to a device for producing a wet granulated substance for an electrode by stirring a solid component and a liquid component together and a method of producing the same.

### 2. Description of Related Art

An electrode active material and other solid components may be stirred with a liquid component to prepare a mixture. The mixture may be adhered to a current collecting foil and then dried to prepare an electrode sheet. Here, in recent years, the use of a mixture called a wet granulated substance in which a proportion of a liquid component is reduced has been proposed. The mixture is used to reduce the burden resulting from a drying process and the like. As an example of such a technique, a technique described in Japanese Patent Application Publication No. 2015-201318 (JP 2015-201318 A) may be exemplified.

### SUMMARY

However, when an electrode sheet is prepared using a wet granulated substance, defects are likely to occur in an electrode active material layer. This is thought to be caused by the fact that locally there may be a part in which there is insufficient liquid component in the wet granulated substance. Since a proportion of a liquid component is low as a whole, such a part in which locally there is insufficient liquid component is thought to easily occur. In particular, when a liquid component having a high viscosity is used, defects occur more easily in an electrode active material layer.

The present disclosure provides a production device and a production method through which it is possible to obtain a favorable wet granulated substance for an electrode by uniformly mixing a solid component with a liquid component such that a part in which there is insufficient liquid component does not occur.

A first aspect of the present disclosure relates to a device for producing a wet granulated substance for an electrode, including a storage tank in which a solid component of the wet granulated substance that is a material for the electrode of a battery is stored, a liquid supply unit configured to supply a liquid component of the wet granulated substance to the solid component stored in the storage tank, and a stirring member configured to rotate in the storage tank and to stir the solid component and the liquid component together. In the first aspect of the present disclosure, the liquid supply unit includes a nozzle configured to allow the liquid component to drop from above the storage tank, a pump that is provided upstream from the nozzle and configured to repeatedly switch between a first state in which a pressure is applied to the liquid component so that the liquid component drops from the nozzle and a second state in which a lower pressure than in the first state is applied to the liquid component so that the liquid component does not drop from the nozzle, and a rotating member that is provided between the nozzle and the storage tank, has a disk shape with irregularities formed on an edge of the disk shape and is configured to rotate in a non-horizontal plane. In the first aspect of the present disclosure, the rotating member may be disposed at a position at which the liquid component dropping from the nozzle is received in a recess of the rotating member facing upward due to rotation and, when the recess in which the liquid component is received faces downward due to rotation, the liquid component received in the recess drops toward the storage tank.

A second aspect of the present disclosure relates to a method of producing a wet granulated substance for an electrode including storing a solid component of the wet granulated substance that is a material for the electrode of a battery in a storage tank, supplying a liquid component of the wet granulated substance to the solid component stored in the storage tank, and rotating a stirring member in the storage tank and stirring the solid component and the liquid component together. In the second aspect of the present disclosure, when the liquid component is supplied, the liquid component drops from the nozzle that is provided above the storage tank, a pump that is provided upstream from the nozzle repeatedly switches between a first state in which a pressure is applied to the liquid component so that the liquid component drops from the nozzle and a second state in which a lower pressure than in the first state is applied to the liquid component so that the liquid component does not drop from the nozzle, a rotating member that is provided between the nozzle and the storage tank and has a disk shape with irregularities formed on an edge of the disk shape rotates in a non-horizontal plane, the liquid component dropping from the nozzle is received in a recess of the rotating member facing upward due to rotation of the rotating member, and the liquid component received in the recess drops toward the storage tank when the recess in which the liquid component is received faces downward due to rotation. The liquid component has a viscosity of 8000 Pa·s or less. The rotating member has a rotational speed of 200 to 800 rpm.

According to the above aspect, small amounts of a liquid component are dispersed and supplied to a plurality of positions in a solid component of a wet granulated substance for an electrode. In this state, the solid component and the liquid component are stirred together by the stirring member to form a wet granulated substance for an electrode. Accordingly, in the obtained wet granulated substance for an electrode, the solid component and the liquid component are uniformly mixed together, and a solid content has almost no variation according to location. Therefore, when the wet granulated substance for an electrode is used, it is possible to produce an electrode sheet including a favorable electrode active material layer having no defects.

In the above aspect, a surface of the rotating member may be made of a fluororesin. The reason for this is to obtain a high resistance and low wettability with respect to the liquid component and prevent foreign substances from being generated.

In the above aspect, the liquid component may be a solution in which a binding agent is dissolved in an organic solvent. A solution containing a binding agent generally has a high viscosity. Therefore, when a liquid component is continuously supplied to the solid component, it is difficult for the liquid component to uniformly spread throughout the solid component, and variation is likely to occur in the solid content according to location. In any case, when the production device or production method according to any one of the above aspects is used, it is possible to address such problems.

In the above aspect, the second state may be a non-pressurized state in which the pump applies no pressure to the liquid component.

In the above aspect, in the second state, a discharge pressure applied by the pump to the liquid component from the nozzle may be a negative pressure. This is because discharge of the liquid component from the nozzle can be reliably interrupted and a form of droplets can be discharged.

According to this configuration, there are provided a production device and a production method through which a solid component and a liquid component are uniformly mixed together so that there are no parts in which there is insufficient liquid component and it is possible to obtain a favorable wet granulated substance for an electrode.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a perspective view showing a configuration of a device for producing a wet granulated substance for an electrode according to an embodiment;

FIG. 2 is a front view showing states in which a liquid component discharged from a nozzle drops via a wheel with protrusions and recesses;

FIG. 3 is a perspective view showing a state in which a wet granulated substance for an electrode is produced by the device for producing a wet granulated substance for an electrode according to the embodiment;

FIG. 4 is a schematic diagram showing a state in which a liquid component is supplied according to an embodiment;

FIG. 5 is a perspective view showing a state in which an electrode sheet is produced using the wet granulated substance for an electrode produced according to the embodiment; and

FIG. 6 is a graph showing a relationship between a solid content variation in a wet granulated substance for an electrode and a rate of adhesion (residual proportion) to a roller during transfer.

### DETAILED DESCRIPTION OF EMBODIMENTS

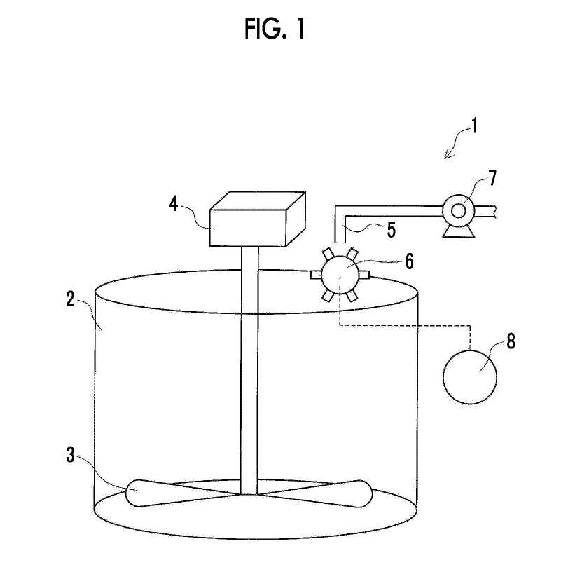

Exemplary embodiments of the present disclosure will be described in detail below with reference to the appended drawings. The present embodiment is an embodiment of the present disclosure that provides a production device for producing a wet granulated substance for an electrode by mixing a solid component of a wet granulated substance for an electrode that is a material for a battery electrode with a liquid component and a method of producing the same. In particular, the present embodiment relates to a production device and a production method which are suitable for producing a wet granulated substance for an electrode having a liquid component whose proportion is lower than that in a so-called paste. FIG. 1 shows a configuration of a device 1 for producing a wet granulated substance for an electrode according to the present embodiment. The production device 1 in FIG. 1 includes a storage tank 2, a stirring member 3, a motor 4, a nozzle 5, a wheel with protrusions and recesses 6, a pump 7, and a motor 8.

The storage tank 2 is a container in which a solid component is stored. The stirring member 3 rotates in the storage tank 2 and stirs an object contained in the storage tank 2. The motor 4 is a rotary drive source of the stirring member 3. The nozzle 5 drops a liquid component onto the solid component in the storage tank 2 from above the storage tank 2. The wheel with protrusions and recesses 6 is a disk-shaped rotating member that is provided on a path along which a liquid component dropping from the nozzle 5 falls and has irregularities formed on the edge. The wheel with protrusions and recesses 6 is provided to rotate in a non-horizontal plane. The pump 7 applies a pressure at a position upstream from the nozzle 5 along a liquid component supply path so that a liquid component is discharged from the nozzle 5. However, in the present embodiment, as will be described below, a pressure is intermittently applied. The motor 8 is a rotary drive source of the wheel with protrusions and recesses 6.

In the production device 1 configured as described above, a wet granulated substance for an electrode is produced as follows. First, an electrode active material powder is stored in the storage tank 2. The electrode active material powder is a solid component of the wet granulated substance for an electrode. Here, powders of a conductive material and other additive components may be stored in the storage tank 2 together with the electrode active material powder. Then, the nozzle 5 is used to allow a liquid component to drop onto the electrode active material in the storage tank 2 from above the storage tank 2. In this case, the stirring member 3 is rotated by the motor 4. This is performed to stir and mix the dropped liquid component with the electrode active material.

Here, in the present embodiment, a liquid component is discharged intermittently rather than continuously from the nozzle 5. Therefore, the pump 7 is intermittently driven to repeatedly switch between a pressurized state (a first state) and a non-pressurized state (a second state). Therefore, a liquid component is discharged dropwise rather than continuously from the nozzle 5. Furthermore, in the present embodiment, a liquid component discharged from the nozzle 5 does not drop directly onto the electrode active material but is received temporarily in the wheel with protrusions and recesses 6.

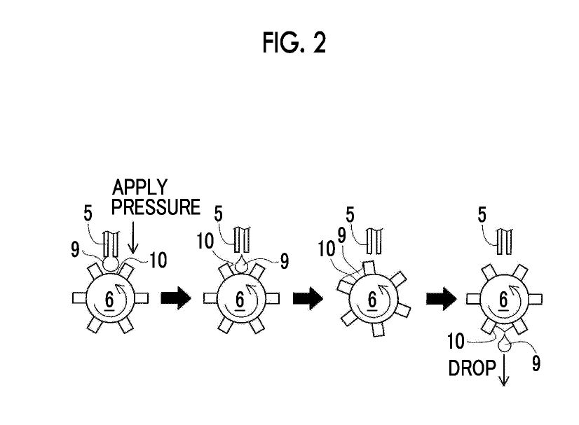

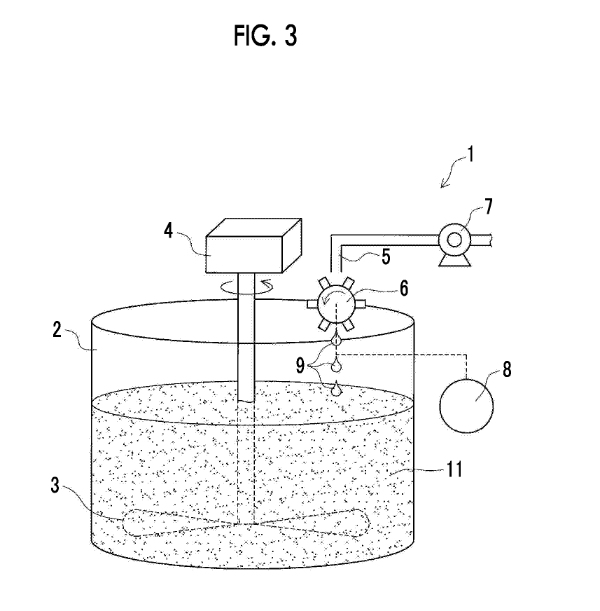

That is, the wheel with protrusions and recesses 6 is disposed at a position at which the liquid component discharged from the nozzle 5 falls to a position on the upper side in a vertical direction within the edge. In addition, when a liquid component is intermittently discharged from the nozzle 5, the wheel with protrusions and recesses 6 is rotated by the motor 8. Accordingly, as shown in the leftmost diagram in FIG. 2, a droplet 9 discharged from the nozzle 5 due to pressurization by the pump 7 is received in a recess 10 that is positioned on the upper side due to rotation of the wheel with protrusions and recesses 6. Then, as shown in the second leftmost diagram in FIG. 2, when pressurization by the pump 7 is stopped, discharge of a liquid component from the nozzle 5 is interrupted temporarily, and the droplet 9 separates from the nozzle 5. Then, as shown in the second rightmost diagram in FIG. 2, the droplet 9 is moved due to rotation of the wheel with protrusions and recesses 6 while being held in the recess 10. Then, as shown in the rightmost diagram in FIG. 2, when the recess 10 holding the droplet 9 is positioned on a lower side in the wheel with protrusions and recesses 6, the droplet 9 separates from the recess 10 and falls downward due to the force of gravity. Accordingly, as shown in FIG. 3, the liquid component reaches an electrode active material 11 dropwise as the droplets 9 rather than continuously.

Here, as a material of a surface of the wheel with protrusions and recesses 6, a synthetic resin is more preferable than a metal. This is because, when a metal is used for a surface of the wheel with protrusions and recesses 6, metallic foreign substances may be mixed into a wet granulated substance for an electrode to be produced. If a synthetic resin is used, such mixing in does not occur. In addition, a material having resistance to a liquid component and having low wettability with respect to a liquid component is preferable. For example, when N-methyl-2-pyrrolidone (NMP) is used as a liquid component, a fluororesin can be suitably used as a material for a surface of the wheel with protrusions and recesses 6. Of course, not only the surface but also the entire wheel with protrusions and recesses 6 may be formed of a fluororesin or another synthetic resin.

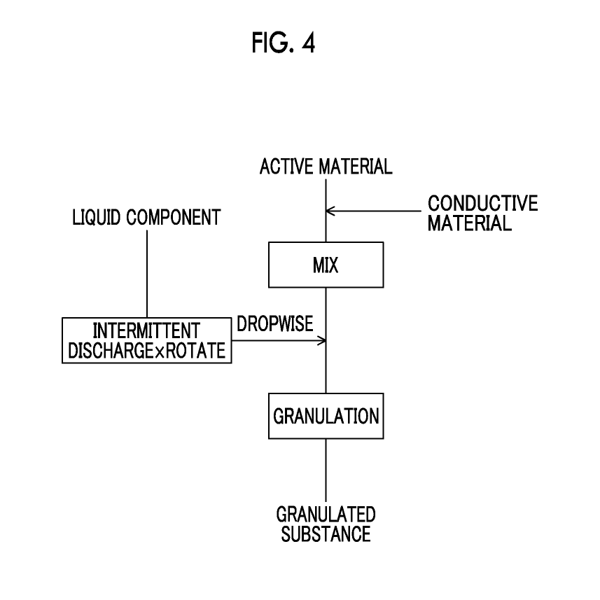

FIG. 4 schematically shows the supply of a liquid component in the production device 1 according to the present embodiment. When a liquid component is supplied dropwise to an electrode active material (and an additive) that is stirred by the stirring member 3, the electrode active material and the liquid component are uniformly mixed together in the storage tank 2. This is because, unlike a case in which a liquid component is continuously supplied, small amounts of a liquid component are dispersed and drop onto a plurality of positions in the electrode active material. Therefore, when the entire mixture in the storage tank 2 is observed, there is almost no differences in which there is a part including a large amount of an electrode active material and a small amount of a liquid component and a part including a small amount of an electrode active material and a large amount of a liquid component. Accordingly, a favorable wet granulated substance for an electrode in which an electrode active material and a liquid component are uniformly mixed together is obtained.

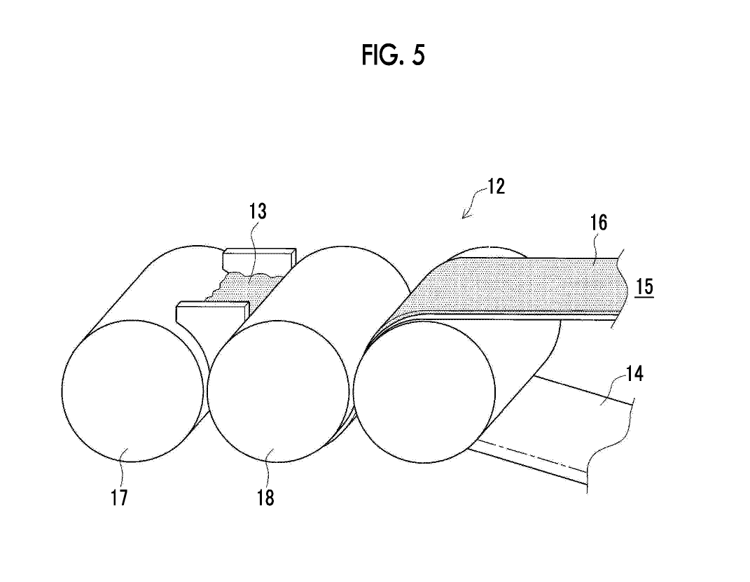

When the granulated substance obtained in this manner is used, for example, as shown in FIG. 5, it is possible to produce an electrode sheet. In FIG. 5, a wet granulated substance for an electrode 13 is transferred to a current collecting foil 14 using a 3-roller type transfer device 12 and an electrode sheet 15 is obtained. In the obtained electrode sheet 15 in FIG. 5, a favorable electrode active material layer 16 having almost no defects is formed. The wet granulated substance for an electrode 13 used is uniform as described above so that the electrode active material layer 16 has almost no defects.

Next, examples (including comparative examples) will be described. First, various materials used in the examples are as follows.

Electrode active material: nickel cobalt manganese composite lithium oxide
Conductive material: acetylene black (HS-100)
Liquid component: a solution in which a binding agent is dissolved in an organic solvent

Binding agent: PVDF (polyvinylidene fluoride)

Organic solvent: NMP

Current collecting foil: aluminum foil

In a composite lithium oxide used as an electrode active material, a composition ratio of nickel:cobalt:manganese was 0.38:0.32:0.30. In addition, a compositional proportion of a liquid component was controlled such that it had three levels according to a viscosity. While the NMP itself had a low viscosity that was not different from that of water, three levels of viscosity such as 3000, 8000, and 12000 [mPa·s] were obtained by adding a binding agent. In addition, a composition ratio between an electrode active material, a conductive material and a liquid component was set so that a dried electrode active material layer had a composition ratio by weight that was 94.5:4:1.5 (electrode active material:conductive material:binding agent).

Various conditions in which wet granulated bodies for an electrode were produced and results are shown in Table 1. Meanings in columns in Table 1 are as follows.

Solution viscosity: a viscosity of a liquid component
Rotational speed: a rotational speed of the wheel with protrusions and recesses 6
Degree of pressure: a pressure [MPa] applied by the pump 7 when a liquid component was discharged (during pressurization)
Degree of decompression: a pressure [MPa] applied by the pump 7 when a liquid component was not discharged (during no pressurization)
Diameter of droplets: a diameter of the droplets 9 captured by a high speed camera [mm]
Variation: variation in a solid content in a wet granulated substance for an electrode
Residual proportion: a proportion [%] which was a residue when a wet granulated substance for an electrode was transferred to a current collecting foil
Number of defects: the number of defects per 500 m in a longitudinal direction in a produced electrode sheet
Evaluation: evaluation result for a produced electrode sheet

Among the above items, the variation, the residual proportion, and the evaluation will be described in further detail as follows.

Variation: a variation in weight obtained after drying the produced wet granulated substance for an electrode that was divided into several portions equal in weight and then dried.

Residual proportion: a percentage by weight of the wet granulated substance for an electrode 13 remaining on a first roller 17 or a second roller 18 after transferring with respect to the input wet granulated substance for an electrode 13 during transfer as in FIG.

Evaluation: Evaluation was “A” when the number of defects was 0, evaluation was “B” when the number of defects was 1 or more and 5 or less, and evaluation was “C” when the number of defects was 6 or more.

TABLE 1

| | | | Degree | | | | | Number | |
|---|---|---|---|---|---|---|---|---|---|
| | Solution | Rotational | of | Degree of | Diameter of | | Residual | of | |
| | viscosity | speed | pressure | decompression | droplets | Variation | proportion | defects | Evaluation |
| Comparative | 12000 | Zero | 0.3 | Zero | Continuous | 1.1 | 1.97 | 60 or | C |
| Example 1 | | | | | discharge | | | more | |
| Comparative | | 4000 rpm | 0.5 | −0.02 | 5 | 0.86 | 1.78 | 40 or | |
| Example 2 | | | | | | | | more | |
| Comparative | | | 0.3 | | 4 | 0.5 | 1.1 | 18 | |
| Example 3 | | | | | | | | | |
| Comparative | | 800 rpm | 0.5 | | Cobwebbing | No data | | | |
| Example 4 | | | | | | | | | |
| Comparative | | | 0.3 | | | | | | |
| Example 5 | | | | | | | | | |
| Comparative | 8000 | 4000 rpm | 0.5 | | Excessive | | | | |
| Example 6 | | | | | dispersion | | | | |
| Comparative | | | 0.3 | | | | | | |
| Example 7 | | | | | | | | | |
| Example 1 | | 800 rpm | 0.5 | | 1.2 | 0.1 | 0 | 0 | A |
| Example 2 | | | 0.3 | | 2 | 0.1 | 0 | 0 | A |
| Example 3 | 4000 | | 0.5 | | 2.5 | 0.15 | 0.2 | 3 | B |
| Example 4 | | | 0.3 | | 2 | 0.1 | 0 | 0 | A |
| Example 5 | | | 0.2 | | 1.5 | 0.1 | 0 | 0 | A |

In Comparative Example 1, a wheel with protrusions and recesses 6 was not provided in the production device 1, and a pressure was continuously applied by the pump 7. On the other hand, in Comparative Examples 2 to 7 and Examples 1 to 5, the wheel with protrusions and recesses 6 was provided in the production device 1, and a driving state of the pump 7 was alternately switched between pressurization and non-pressurization. Here, in Table 1, as can be seen from the fact that the numerical value in the column of “degree of decompression” is negative (excluding Comparative Example 1), in the experiment of this example, a discharge pressure of the liquid component from the nozzle 5 in the non-pressurized state of the pump 7 was set as a negative pressure. This is because it was difficult to stop discharge of the liquid component from the nozzle 5 when pressurization was simply turned off, particularly when the liquid component had a high viscosity. However, this is not essential, and simply turning the pressurization off may be sufficient when the liquid component has a low viscosity.

In Comparative Example 1 in Table 1, “continuous discharge” is in the “diameter of droplets” column. This indicates that a liquid component was continuously discharged from the nozzle 5 rather than in the form of droplets. Therefore, the “variation” in the completed wet granulated substance for an electrode was large, and is the highest in all of Table 1. This indicates that a solid content of the completed wet granulated substance for an electrode was irregular depending on location. Therefore, the “residual proportion” during actual transfer and “the number of defects” are also the highest in Table 1. As a result, evaluation was “C.”

In Comparative Examples 2 and 3, a solution viscosity was 12000 [mPa·s] which was the same as in Comparative Example 1, and the wheel with protrusions and recesses 6 was rotated at a high speed of 4000 rpm. In these examples, a liquid component was discharged from the nozzle 5 dropwise rather than continuously. However, the diameter of the droplets 9 was large. In addition, in Comparative Example 2 in which a pressure was slightly higher during pressurization by the pump, the diameter of the droplets 9 was slightly larger. This is thought to have been caused by the fact that an amount of a liquid component discharged temporarily from the nozzle 5 was somewhat larger according to an applied pressure. In both of Comparative Examples 2 and 3, the “variation” was large and was not improved much compared to that of Comparative Example 1. This is similar for the “residual proportion” and “the number of defects.” As a result, evaluation was “C.” This is thought to have been caused by the fact that, since the diameter of the droplets 9 was large, an effect of dispersing and supplying a liquid component was insufficient.

Comparative Examples 4 and 5 were performed under the same conditions as for Comparative Examples 2 and 3 except that a rotational speed of the wheel with protrusions and recesses 6 was reduced to 800 rpm. However, in Comparative Examples 4 and 5, a liquid component dropped from the wheel with protrusions and recesses 6 in the form of cobwebbing. This is because, since the liquid component had a high viscosity and the wheel with protrusions and recesses 6 had a low rotational speed, the droplets 9 discharged from the nozzle 5 stuck together on the wheel with protrusions and recesses 6. Since there was not much difference from that of the continuous discharge of Comparative Example 1, the “variation” was not measured and the transfer experiment was not performed in Comparative Examples 4 and 5. As a result, evaluation was “C.”

Comparative Examples 6 and 7 were performed under the same conditions as for Comparative Examples 2 and 3 except that a viscosity of the liquid component was reduced to 8000 [mPa·s] (somewhat lower viscosity than honey). However, in Comparative Examples 6 and 7, the liquid component was horizontally dispersed from the wheel with protrusions and recesses 6. The dispersed liquid component adhered to a wall surface of the storage tank 2 and did not reach the electrode active material 11. This is thought to have been caused by the fact that the droplets 9 received in the recesses 10 of the wheel with protrusions and recesses 6 were dispersed due to the centrifugal force generated by rotation of the wheel with protrusions and recesses 6 before reaching a position on the lower side of the wheel with protrusions and recesses 6. In this case, since the obtained wet granulated substance for an electrode did not have a desired composition, the “variation” was not measured and the transfer experiment was not performed in Comparative Examples 6 and 7. As a result, evaluation was “C.”

Examples 1 and 2 were performed under the same conditions as for Comparative Examples 6 and 7 except that a rotational speed of the wheel with protrusions and recesses 6 was reduced to 800 rpm. In these examples, the liquid component was discharged from the nozzle 5 dropwise, and the diameter of the droplets 9 below the wheel with protrusions and recesses 6 was as small as 2 mm or less. Therefore, the “variation” was significantly smaller than in Comparative Examples 1 to 3. Here, the “residual proportion” and “the number of defects” were 0. As a result, evaluation was “A.”

Examples 3 and 4 were performed under the same conditions as for Examples 1 and 2 except that a viscosity of the liquid component was reduced to 4000 [mPa·s]. In Example 5, a pressure during pressurization by the pump was slightly lower than that of Example 2. In these examples, results similar to those of Examples 1 and 2 were obtained. Example 3 in which the diameter of the droplets 9 was slightly larger was evaluated as “B” and Examples 4 and 5 were evaluated as “A.”

Here, even if a rotational speed of the wheel with protrusions and recesses 6 was reduced to 800 rpm as in Examples 1 to 5, one drop of the droplets 9 discharged from the nozzle 5 was received in several recesses 10 in a divided manner in the wheel with protrusions and recesses 6. Therefore, there was no need to synchronize a timing at which a liquid component was discharged from the nozzle 5 and a timing at which the recesses 10 in the wheel with protrusions and recesses 6 faced the nozzle 5. However, when a rotational speed of the wheel with protrusions and recesses 6 was too low, the presence of the wheel with protrusions and recesses 6 had no significance. Therefore, 200 rpm was set as a lower limit.

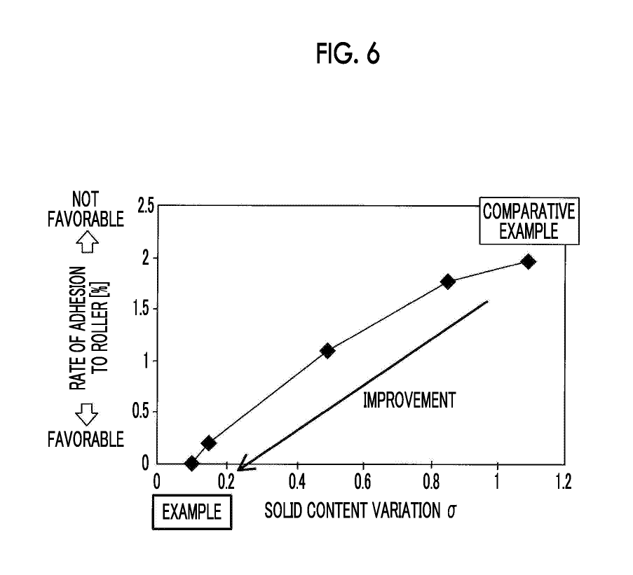

Here, a relationship between the “variation” and the “residual proportion” (a rate of adhesion to a roller) in Table 1 is shown in the graph of FIG. 6. In the graph of FIG. 6, the upper right side indicates a less favorable result and the lower left side indicates a favorable result. Here, the plot on the upper right side in the graph in FIG. 6 corresponds to Comparative Examples 1 to 3 and the plot on the lower left side corresponds to Examples 1 to 5. It can be understood that an improvement effect according to the present disclosure is exhibited.

As described above in detail, according to the present embodiment and the examples, a liquid component is discharged intermittently from the nozzle 5 according to repetitive driving of the pump 7. Further, a liquid component discharged from the nozzle 5 is received temporarily in the recess 10 of the wheel with protrusions and recesses 6 that rotates and drops to the electrode active material 11. Accordingly, small amounts of a liquid component are dispersed and supplied to a plurality of positions in the electrode active material 11. Accordingly, a production device and a production method through which a favorable wet granulated substance for an electrode in which an electrode active material and a liquid component are uniformly mixed together is obtained are realized. Here, among the above conditions, the “solution viscosity” is a property of a material used, and the “rotational speed” is an operation condition. Since these are not properties of the production device, these properties do not limit the production device of the disclosure.

In addition, the present embodiment is only an example, and does not limit the present disclosure. Accordingly, various improvements and modifications can be made without departing from the spirit and scope of the present disclosure. For example, the electrode active material used is an example and other components may be used. In addition, in the pump 7, a negative pressure state during non-pressurization is not a necessary condition. Depending on properties of a liquid component to be used, it may be sufficient simply to turn pressurization off during non-pressurization. In addition, the rotation of the stirring member 3 is not necessarily performed in the horizontal plane. In addition, there is no need to dissolve a binding agent in a liquid component in advance, and the present disclosure can be applied to when a low viscosity liquid such as water is used.

What is claimed is:

1. A device for producing a wet granulated substance for an electrode comprising:
a storage tank in which a solid component of the wet granulated substance that is a material for the electrode of a battery is stored;
a liquid supply unit configured to supply a liquid component of the wet granulated substance to the solid component stored in the storage tank; and
a stirring member configured to rotate in the storage tank and to stir the solid component and the liquid component together,
wherein the liquid supply unit includes:
a nozzle configured to allow the liquid component to drop from above the storage tank;
a pump that is provided upstream from the nozzle and configured to repeatedly switch between a first state in which a pressure is applied to the liquid component so that the liquid component drops from the nozzle and a second state in which a lower pressure than in the first state is applied to the liquid component so that the liquid component does not drop from the nozzle; and
a rotating member that is provided between the nozzle and the storage tank, has a disk shape with irregularities formed on an edge of the disk shape and is configured to rotate in a non-horizontal plane.

2. The device for producing a wet granulated substance for an electrode according to claim 1,
wherein the rotating member is disposed at a position at which the liquid component dropping from the nozzle is received in a recess of the rotating member facing upward due to rotation and, when the recess in which the liquid component is received faces downward due to rotation, the liquid component received in the recess drops toward the storage tank.

3. The device for producing a wet granulated substance for an electrode according to claim 1,
wherein the second state is a non-pressurized state in which the pump applies no pressure to the liquid component.

4. The device for producing a wet granulated substance for an electrode according to claim 1,
wherein, in the second state, a discharge pressure applied by the pump to a liquid component from the nozzle is a negative pressure.

5. The device for producing a wet granulated substance for an electrode according to claim 1,
wherein a surface of the rotating member is made of a fluororesin.

6. A method of producing a wet granulated substance for an electrode comprising:
storing a solid component of the wet granulated substance that is a material for the electrode of a battery in a storage tank;
supplying a liquid component of the wet granulated substance to the solid component stored in the storage tank; and
rotating a stirring member in the storage tank and stirring the solid component and the liquid component together,
wherein, when the liquid component is supplied,
the liquid component drops from a nozzle that is provided above the storage tank;
a pump provided upstream from the nozzle repeatedly switches between a first state in which a pressure is applied to the liquid component so that the liquid component drops from the nozzle and a second state in which a lower pressure than in the first state is applied to the liquid component so that the liquid component does not drop from the nozzle;
a rotating member that is provided between the nozzle and the storage tank and has a disk shape with irregularities formed on an edge of the disk shape is rotated in a non-horizontal plane;
the liquid component dropping from the nozzle is received in a recess of the rotating member facing upward due to rotation of the rotating member; and
the liquid component received in the recess drops toward the storage tank when the recess in which the liquid component is received faces downward due to rotation,
wherein the liquid component has a viscosity of 8000 Pa·s or less, and
wherein the rotating member has a rotational speed of 200 to 800 rpm.

7. The method of producing a wet granulated substance for an electrode according to claim 6,
wherein the liquid component is a solution in which a binding agent is dissolved in an organic solvent.

8. The method of producing a wet granulated substance for an electrode according to claim 6,
wherein the second state is a non-pressurized state in which the pump applies no pressure to the liquid component.

9. The method of producing a wet granulated substance for an electrode according to claim 6,
wherein, in the second state, a discharge pressure applied by the pump to the liquid component from the nozzle is a negative pressure.
